(19) United States
(12) Patent Application Publication
(10) Pub. No.: US 2024/0292382 A1
(43) Pub. Date: Aug. 29, 2024

(54) Method for processing a connection between user equipment and remote equipment in a communication network, and corresponding control method, devices, satellite, ground station, system and computer programs

(71) Applicant: ORANGE, Issy-les-Moulineaux (FR)

(72) Inventors: Emile Stephan, CHATILLON CEDEX (FR); Veronica Quintuna Rodriguez, CHATILLON CEDEX (FR)

(21) Appl. No.: 18/573,022

(22) PCT Filed: Jun. 29, 2022
(86) PCT No.: PCT/FR2022/051294

§ 371 Date: Dec. 21, 2023

(30) Foreign Application Priority Data
Jun. 30, 2021 (FR) FR2107094

(51) Int. Cl. H04W 72/04; H04L 43/0829; H04W 76/19

(52) U.S. Cl. CPC H04W 72/04; H04L 43/0829; H04W 76/19

(57) ABSTRACT

A method for processing a connection between user equipment and remote equipment in a communication network. The user equipment is attached to a wireless access network of the communication network via a wireless link. The method includes: detecting an underutilization of a data rate allocated to the connection over the wireless link; obtaining padding data, the data being stored in a memory accessible within the communication network; and transmitting the padding data thus obtained over the wireless link.

### 1. FIELD OF THE INVENTION

The field of the invention is that of a communication network, to which user equipment is connected.

In particular, the invention relates to the processing of a connection between this user equipment and remote equipment via the communication network, when the user equipment is attached to a wireless access network of this communication network.

It is notably, but not exclusively, applicable to a mobile communication network, for example of 5th generation or 5G.

### 2. PRIOR ART AND ITS DRAWBACKS

In contrast to the preceding generations, 5G provides for division of the mobile radio access network (RAN) into network functions NF, independent of the physical network elements. It principally consists of the following functions: a radio level remote unit RU, a radio processing and scheduling distributed unit DU and a centralized unit CU toward the core network. Several variants for subdivision of these functions, called “splits”, have been provided, depending on the objectives for concentration of the functions of the RAN.

A compromise nevertheless needs to be found between the benefits of the centralization and the cost of the additional links resulting from the subdivision of these functions over several physical network elements, notably the links referred to as “fronthaul” (or FH) between the units DU and RU. FIG. 1 shows a family of “splits” called intra-physical layer splits which is known from the prior art (variants 8, 7.1, 7.2 and 7.3).

In relation with FIG. 2, the interfaces between the virtualized network functions CU, DU and RU are described. The interface F1 between the functions CU and DU is specified in part by the 3GPP which has defined deployment scenarios in which the interface F1 is entirely interoperable.

The interface F2 between the functions DU and RU, called “Low Layer Split” (LLS) interface or also “open FrontHaul”, is an open interface, in contrast to an interface of the CPRI (Common Public Radio Interface) type generally used between a base station and its antennas. It is also specified by the 3GGP notably for the variant split 7.2.

In parallel and in order to improve the radio coverage in certain geographical regions, 5G network architectures based on constellations of satellites have been provided, as illustrated by FIG. 3. According to this example, user equipment UE is connected to a web server via a radio network RAN comprising a satellite SAT1 with the onboard functions RU and DU and a ground station NTN_GW1 (or “terrestrial gateway”) with the onboard function CU. Another option shown in FIG. 3 is that the satellite SAT1 only has the onboard function RU and that the function DU is integrated into a second ground station NTN_GW2. According to yet another option, the function DU is on board an intermediary satellite SAT of the network RAN.

More generally, all or part of the virtualized functions (RU, DU, CU) of the RAN may be distributed over one or more satellites of a constellation and one or more ground stations. This is referred to as satellite RAN. Compared with a terrestrial radio access network RAN, it involves at least one additional radio connection, for example of the e-CPRI type, in order to connect the satellite to the ground station then to the mobile network core, or even more when the virtualized functions are distributed over several satellites, with the use of ISL (Inter Satellite Link) links between satellites.

Irrespective of the configuration chosen, the distance between these virtualized functions (and as a consequence the latency) must be minimized in order to comply with the timings established for 5G. Notably, the latency between the function RU and the function DU must be less than a millisecond. In other words, when the function DU is itself also localized in space (like the function RU), the system is less sensitive to the latency between the satellite and the ground station at least as far as the mobile radio processing is concerned.

Similarly, the function CU may also be placed within the constellation of satellites, in the ground station or even in equipment of a remote data center.

However, these various configurations produce several data packet loss scenarios able to affect, as illustrated by FIG. 3, the three links marked with a cross. These are in particular the intra-constellation link between the function RU and the function DU, and, according to the examples, the link between the function DU situated within the constellation and the function CU situated in the ground station or else the link between the function DU situated in the ground station and the function CU situated in equipment of a remote data center.

When data packet losses are noted by radio equipment of the RAN, the function concerned, for example RU/DU, requests the retransmission of the lost packet to the remote function CU and, during this lapse of time, the resources allocated to the connection over the radio link with the user equipment are under-utilized.

Furthermore, the convergence time of the congestion control algorithms for the end-to-end transport connections according to protocols such as TCP or QUIC between user equipment and server equipment via such a mobile network leads to a waste of radio data rate at the establishment or re-establishment of such a connection. Indeed, this convergence time or THRPT (for “throughput”) is generally of the order of several RTTs (Round Trip Times) between the source (the user equipment) and the destination (the server equipment or proxy equipment), as illustrated in FIG. 4.

That said, the radio resources remain rare resources.

There accordingly exists a need for a solution to reduce such a waste and avoid an under-utilization of resources which are reserved for a connection between user equipment and its destination.

The invention will improve the situation.

### 3. Description of the Invention

The invention meets this need by providing a method for processing a connection between user equipment and remote equipment within a communication network, said user equipment being attached to a wireless access network of said communication network via a wireless link, said method comprising:
detecting an under-utilization of a data rate allocated over said wireless link to said connection;
obtaining padding data, said data being stored in a memory accessible within the communication network; and
transmitting the padding data obtained over said wireless link.

The invention provides a completely novel and inventive approach for reducing the waste of wireless transmission resources, which consists in detecting an under-utilization of the resources allocated to a connection over the wireless link between user equipment and the access network to which it is attached, and in transmitting padding data over this wireless link, these padding data having previously been made available in a memory accessible within the communication network (e.g. in the access network and/or in the core network).

The invention relates in particular to end-to-end communications in connected mode, implementing for example transport layer level protocols of the TCP (Transport Communication Protocol) or QUIC type, which require a connection to be established prior to sending data. According to this type of connection, the transmitter sequences the data and controls the streams, the receiver acknowledges receipt of the data so that the packet losses are detected and the lost packets are retransmitted.

The invention is applicable to any type of wireless access network, for example based on a Wifi, Lifi or cellular radio technology. It is especially adapted to a radio access network RAN of a 5G mobile communication network, notably when it is divided up into several virtual functions which are implemented by one or more satellites and potentially one or more base stations, according to various distribution scenarios. For example, the function RU, which carries out the attachment of the user equipment, is on board such a satellite. The functions DU and CU may be on board this same satellite or else in an intermediary satellite or may be integrated into a ground station.

Compared to a terrestrial RAN, a satellite RAN necessitates at least one additional radio connection for connecting the satellite to a ground station, or even more if a constellation of satellites is used and the sources of congestion or of packet losses are accordingly more numerous.

According to the invention, the padding data may be of various types, corresponding to the various layers of the OSI model. For example, the padding data comprise application data, which are used as a replacement for the lost or missing data (for example a degraded version of an image whose data have not been received), or DNS (Domain Name System) inputs or else computer update data, for example of the operating system of the user equipment, public information data, such as a weather report, a tsunami warning, etc. As a variant, the padding data comprise instructions for generating data intended to replace lost or missing data (for example an instruction of the type “replace the image by text”).

They may also comprise technical data, such as control data at the 5G level or at the radio level.

Advantageously, the memory, for example of the cache memory type, in which the padding data are stored, is integrated into the network equipment nearest to the user equipment, hence situated at one end of the wireless link over which a dearth of data is detected. As a variant, it may be integrated into other equipment of the wireless access network, preferably close to the latter, in order to minimize the latency during the transmission of the padding data from the memory to the network equipment.

It may also be situated in the core network of the communication network.

The padding data may also be read on an input/output interface which has received it from other equipment of the wireless access network, such as an intermediary satellite, or which generates these data in real time based on the instructions received.

The invention is particularly adapted to the transmissions in the downlink direction, from the mobile network to the user equipment, but it is also applicable in the uplink direction. In this case, the cache memory is integrated into the user equipment.

According to one aspect of the invention, the detection of an under-utilization of a data rate comprises the detection of a loss of data packets over another link of the access network implemented by the connection and the padding data are obtained then transmitted following a request for retransmission of the lost packets and prior to receiving the retransmitted packets.

Within an end-to-end connection, when one or more data packets are lost upstream of the wireless link with the user equipment, the equipment of the access network that detects the loss of data sends a request for their retransmission to the server equipment. This results in the radio resources allocated for the transport of these data packets over the downstream radio links not being used during the lapse of time needed for this retransmission.

According to another aspect of the invention, the detection of an under-utilization of a data rate comprises the detection of an establishment and/or re-establishment of said connection and the padding data are obtained then transmitted during a period of convergence of a congestion control.

When a connection is established between the user equipment and the remote equipment, neither of them knows the data rate effectively available over the various links used for transmitting the data via this connection and several round trips or RTTs are needed by the congestion control algorithms in order to converge. During this period, the radio resources are already allocated but are not fully exploited.

When a connection is re-established, the congestion control parameters determined at the establishment of the connection may be incorrectly adjusted following data losses, variations in timing or in data rate, which may lead to an under-utilization of the resources allocated to the connection within the communication network, for the time it takes the congestion control algorithm to re-adjust its configuration.

According to another aspect of the invention, the method comprises the obtaining of information relating to the connection and the prediction of a quantity of said padding data to be requested, by application of a predetermined prediction model to the information obtained.

For example, the information obtained indicates a loss of data packets destined for the user equipment ([ID, domain, AIMD, 10 packet losses, 4 attached losses]) over another link implemented by the connection and situated more upstream on the path followed by the data, between two sets of equipment of the access network (for example between the satellite nearest to the user equipment and another satellite of the constellation or else between the satellite and a ground station). For example, the quantity of padding data predicted is 500 bytes. According to another example, the information obtained indicates a slow establishment of the connection in the direction of the user equipment due to a slow convergence of the congestion control algorithms implemented from end to end within the transport layer ([ID, domain, MIMD, duration of 3 RTTs]) and the quantity of padding data predicted is 10 k bytes or 5 ms of radio transmission.

Advantageously, the predetermined prediction model has previously been received from the communication network. It has for example been produced based on congestion data and on data losses relating to prior connections and stored in a data table which may be managed in distributed or divided up mode.

According to yet another aspect of the invention, the padding data are transmitted over a control channel and/or over a user channel of the wireless link, the channel used for the transmission being determined by a type of the padding data.

Advantageously, the application data are transmitted at the physical level in the user channel and the control data of the access network are transmitted in the control channel. One advantage of the invention is that it allows the initial division of the resources allocated between control and user channels already existing between the virtualized functions to be modified for transmitting the padding data. In this way, the allocated bandwidth is exploited in an optimized manner.

According to yet another aspect of the invention, the padding data are inserted into a data stream of said connection.

One advantage is making use of the established connection. The data stream may be a control data stream or a user data stream. For example, if a loss of packets has occurred, the padding data are inserted into the sub-frames (RB) initially provided for these data packets. This embodiment is adapted to the transmission of padding data destined for an application of the user equipment responsible for the connection established between the user equipment and the remote equipment.

For example, the QUIC/MASQUE technology allows it to be inserted into a stream of the connection for only one segment of the path between the remote equipment and the user equipment.

According to one variant, when the padding data are destined for a non-IP application of the user equipment, they may be sent within a parallel communication channel in one or more messages, for example according to a format specific to the communication networks, such as for example the USSD format for a mobile communication network, as long as the application targeted supports this mode of communication.

The invention also relates to a device for processing a connection between user equipment and remote equipment within a communication network, said user equipment being attached to a wireless access network of said communication network via a wireless link, said device being configured for implementing:
the detection of an under-utilization of a data rate allocated over said wireless link to said connection; and
the obtaining of padding data, said data being stored in a memory accessible within the communication network; and
the transmission of the padding data obtained over said wireless link.

Advantageously, said device is configured for implementing the steps of the processing method such as previously described.

Advantageously, said device is integrated into a satellite of an access network of a communication network, said satellite comprising a memory configured for storing padding data.

For example, this satellite carries on board at least the virtualized function RU of a satellite radio access network RAN according to the 5G standard.

The satellite and the processing device offer at least the same advantages as those offered by the aforementioned processing method.

In a correlated manner, the invention also relates to a method for controlling a connection between user equipment of a communication network and remote equipment, said user equipment being attached via a wireless link to a wireless access network of said communication network, said method comprising:
obtaining padding data intended to be transmitted via said connection in the case of detection of an under-utilization of the resources allocated to this connection by the wireless access network; and
transmitting the padding data obtained to a memory accessible within the communication network, for storage.

For example, the method is implemented by a control device co-located with the virtualized function CU. For example, the control device and the function CU are hosted by a ground station of the access network RAN. The supply of the memory is therefore carried out via a link, for example of the eCPRI type, between the ground station and the satellite hosting the memory.

According to one variant, the aforementioned control device is on board an intermediary satellite which implements the functions DU and RU of the radio access network.

The padding data may be intended for a single set of user equipment. These may for example be data for updating its operating system or else data for DNS inputs.

Advantageously, they may also be intended for a plurality of user terminals which are attached to the same access network, for example to the same cell of a cellular radio access network. One or more of these terminals may not be connected at the moment that the memory is supplied with padding data, but the invention allows them to benefit from some of these data, owing to their proximity with the user equipment involved in the connection. This information is for example linked to public services of the weather report type.

According to one aspect of the invention, the padding data are transmitted to said memory within at least one data stream of the connection.

One advantage is reuse of an existing data stream. According to another embodiment, the method comprises the establishment of a dedicated connection between the network equipment, for example the intermediary satellite or the ground station, which implements the method, and the memory.

For example, the memory which stores the padding data is seen as a “5G end point” of a B2B contract. As an alternative, a dedicated communication tunnel, for example of the VPN type, is established for example according to a technology specific to the satellite operator.

According to another aspect of the invention, the method comprises the obtaining of information relating to a congestion control of the data streams and of information relating to data losses of previous connections in the wireless access network from a data table accessible within the communication network and the selection of the padding data depending at least on the information obtained.

This data table stores a history of the previous connections, notably congestion and loss events that have occurred within the RAN or several RANs.

Advantageously, according to the invention, this data table serves as a basis for establishing a model for prediction of the variations in utilization of the radio resources allocated to an end-to-end connection by radio access equipment of the RAN. Advantageously, it is obtained by concatenation of the contents of tables of local data specific to the various RANs, which allows a sufficiently extensive history of connections to be constituted in order to implement techniques based on artificial intelligence and to determine a prediction model capable of predicting prediction data adapted to the connection. This determination implements for example artificial intelligence (or “Machine Learning”) techniques which exploit the historical connections data stored in the data table.

According to another aspect of the invention, the method comprises the obtaining of at least one model for predicting padding data using information contained in the data table and the transmission of said model within the wireless access network to a device for processing a connection configured for detecting an under-utilization of resources allocated to said connection over a wireless link between the user equipment and the access network, predicting padding data to be used for said connection based on said prediction model and transmitting the predicted padding data over the wireless link.

Advantageously, this prediction model is a computer program which allows types of padding data adapted to the connection to be obtained based on information relating to the connection. It is designed to be used by the processing method according to the invention for selecting the padding data adapted to the connection in the memory. Advantageously, this same prediction model or another, also produced by the control method according to the invention, is intended to be used for selecting the padding data to be pre-positioned in the memory.

According to yet another aspect of the invention, the method furthermore comprises the obtaining of information, coming from the user equipment, relating to a state of at least one cache memory of said user equipment and the selection of padding data adapted to the user equipment depends on the information obtained.

One advantage is that this information allows the access network to prepare upstream the updating of one or more memories of the user equipment, for example the cache memory of its web browser, depending on what it contains, and to pre-position data packets, for example relating to Web or DNS contents, in the cache memory of the radio access network, specifically adapted to the needs of this user equipment. For example, these data packets are placed in a chosen order in a data queue of the FIFO (First In First Out) type.

The invention also relates to a device for controlling a connection established between user equipment of a mobile communication network and remote equipment, said user equipment being attached to a wireless access network of said communication network, said device being configured for implementing:
the obtaining of padding data intended for said at least one connection;
the transmission of the padding data to a memory accessible within the communication network for storage.

Advantageously, said device is configured for implementing the steps of the method for controlling a connection such as previously described.

Advantageously, said device is integrated into an intermediary satellite of an access network of a communication network or into a ground station of the access network or of the core network.

Advantageously, such an intermediary satellite or such a ground station comprises a data table comprising information on congestion and on data losses relating to previous connections.

The intermediary satellite, the ground station and the control device offer at least the same advantages as those offered by the aforementioned control method.

In a correlated manner, the invention also relates to a system of a communication network, comprising the processing device, the control device, the aforementioned memory and data table.

The invention also relates to computer program products comprising program code instructions for the implementation of the methods such as previously described, when they are executed by a processor.

A program may use any given programming language and take the form of source code, object code, or of code intermediate between source code and object code, such as a partially compiled form, or in any other desired form.

The invention is also aimed at a storage medium readable by a computer on which a computer program is stored comprising program code instructions for the execution of the steps of the methods according to the invention such as described hereinabove.

Such a storage medium may be any given entity or device capable of storing the program. For example, the medium may comprise a storage means, such as a ROM, for example a CD ROM or a microelectronic circuit ROM, or else a means of magnetic storage, for example a mobile medium (memory card) or a hard disk or an SSD.

On the other hand, such a storage medium may be a transmissible medium such as an electrical or optical signal, which may be carried via an electrical or optical cable, by radio or by other means, such that the computer program that it contains may be executed remotely. The program according to the invention may in particular be up-/downloaded over a network, for example the Internet.

Alternatively, the storage medium may be an integrated circuit in which the program is incorporated, the circuit being designed for executing, or for being used in the execution of, the aforementioned display control method.

According to one exemplary embodiment, the present technique is implemented by means of software and/or hardware components. In this respect, the term “module” may just as easily correspond in this document to a software component as to a hardware component or to an assembly of hardware and software components.

A software component corresponds to one or more computer programs, one or more sub-programs of a program or, more generally, to any element of a program or of a software application designed to implement a function or a set of functions, according to what is described hereinbelow for the module in question. Such a software component is executed by a data processor of a physical entity (terminal, server, gateway, set-top box, router, etc.) and is able to access the hardware resources of this physical entity (memories, storage media, communication bus, input/output electronic cards, user interfaces, etc.). In the following part, ‘resources’ is understood to mean all assemblies of hardware and/or software elements supporting a function or a service, whether they are stand-alone or combined together.

In the same way, a hardware component corresponds to any element of a hardware assembly designed to implement a function or a set of functions, according to what is described hereinbelow for the module in question. This may be a programmable hardware component or with an integrated processor for the execution of software, for example an integrated circuit, a smart card, a memory card, an electronic card for the execution of firmware, etc.

Each component of the system previously described of course implements its own software modules.

The various embodiments mentioned hereinabove may be combined with one another for the implementation of the present technique.

### 4. BRIEF DESCRIPTION OF THE FIGURES

Other aims, features and advantages of the invention will become more clearly apparent upon reading the following description, given by way of simple illustrative and non-limiting example, in relation with the figures, amongst which:

FIG. 1 (already described) illustrates schematically the virtualization of the functions of a radio access network according to the 5G standard;

FIG. 2 (already described) illustrates schematically the interfaces between the various virtualized functions of a radio access network according to the 5G standard;

FIG. 3 (already described) illustrates schematically one example of a radio access network architecture comprising a satellite;

FIG. 4 (already described) illustrates schematically convergence times of congestion control algorithms of an end-to-end connection in a communication network;

FIG. 5 illustrates schematically an implementation principle of the invention for a radio access network comprising at least one satellite;

FIG. 6 illustrates schematically one example of a radio access network architecture comprising a satellite and a system for managing a connection between user equipment and remote equipment according to one embodiment of the invention;

FIG. 7 describes, in the form of a flow diagram, the steps of a method for processing a connection between user equipment and other remote equipment in a communication network, according to one exemplary embodiment of the invention;

FIG. 8 illustrates schematically the data streams exchanged between the virtualized network functions and the elements of the invention according to one exemplary embodiment;

FIG. 9 describes in the form of a flow diagram the steps of a method for controlling a connection between user equipment and remote equipment, according to one exemplary embodiment of the invention;

FIG. 10 describes, in the form of a flow chart, the exchanges between the user equipment and the various sets of equipment of the access network according to one embodiment of the invention;

FIG. 11 describes, in the form of a flow chart, the exchanges between the user equipment and the various sets of equipment of the access network according to another embodiment of the invention;

FIG. 12 describes one example of a hardware structure of a device for processing a connection according to the invention; and

FIG. 13 describes one example of a hardware structure of a device for controlling a connection according to the invention.

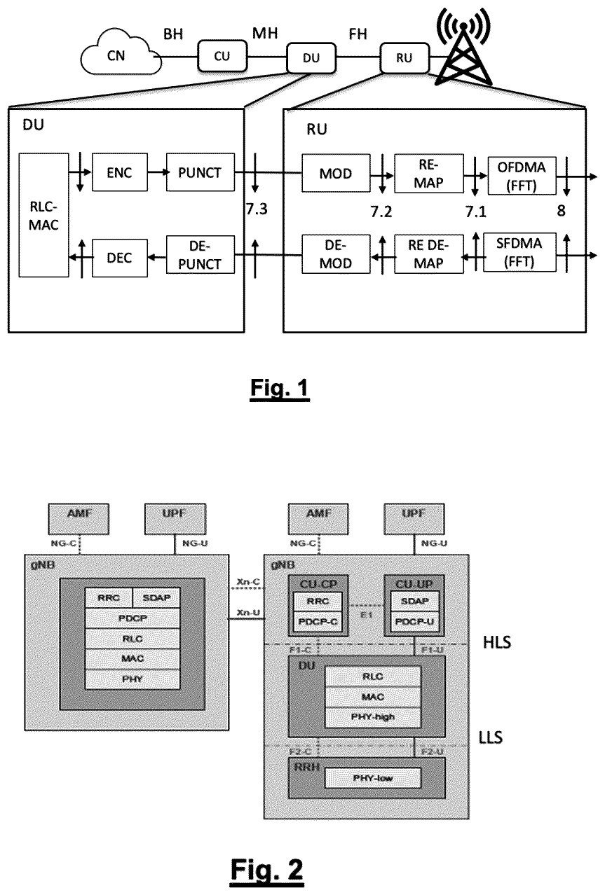

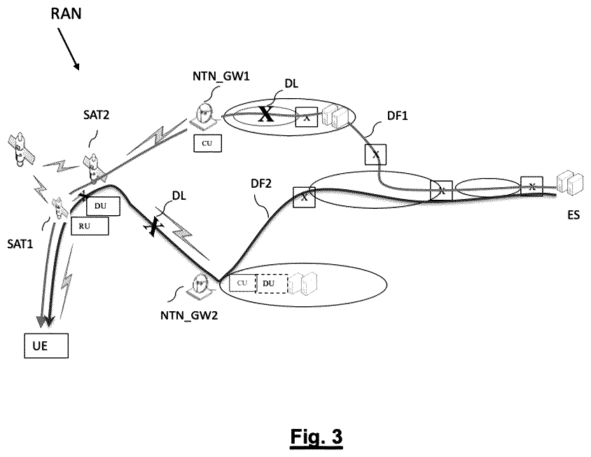

### 5. DETAILED DESCRIPTION OF THE INVENTION

The general principle of the invention is based on the detection of an under-utilization of a data rate allocated over a wireless link between user equipment and an access network to a communication network for a communication between this user equipment and remote equipment within the communication network, for example, connected from end-to-end in client-server mode. Such a detection triggers the obtaining of padding data previously made available in a memory (for example a cache memory for accelerating the execution of the invention), accessible in the access network, and the transmission over said wireless link of said padding data.

When a “dearth” of data, in other words an absence of data to be transported, is detected on the reserved radio channel of the wireless link between the access network and the user equipment, the padding data pre-loaded into a memory of the communication network are used to fill the data frames allocated for the connection. In this way, the utilization of the resources allocated to the connection is optimized.

The invention is particularly adapted to a radio access network of a mobile communication network, in particular a cellular radio access network according to the 5G standard, one or more virtualized functions RU, DU, CU of which are on board one or more satellites.

Nevertheless, the invention is more generally applicable to any type of wireless access network of a communication network, irrespective of the technology used, for example Wi-Fi, Li-Fi, etc.

It relates to both the downlink between the user equipment and the access network and to the uplink from the user equipment to the access network. In this second case, the invention is implemented in the user equipment.

In the following part of the description, an implementation of the invention in a satellite radio network RAN for access to a mobile communication network conforming to the 5G standard is described in more detail.

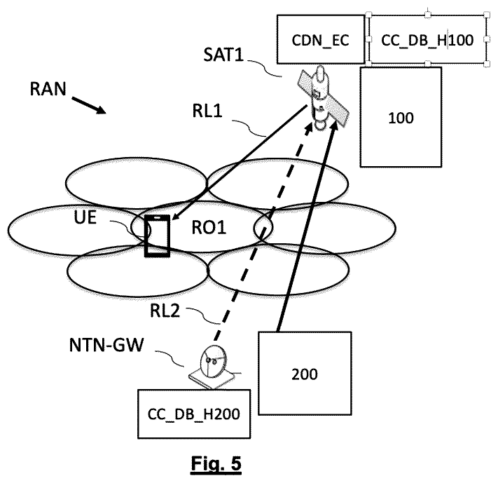

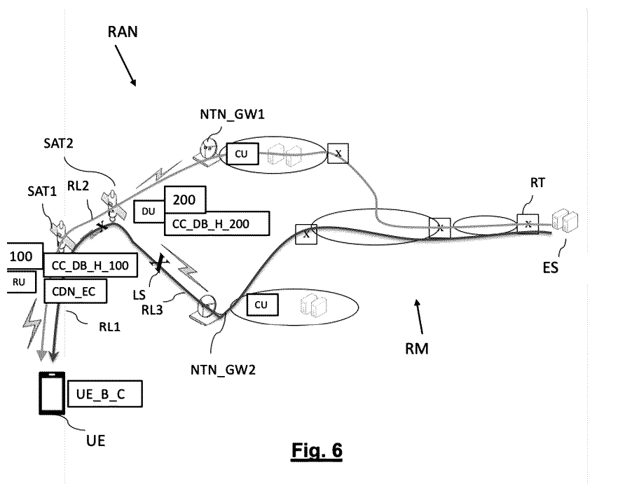

FIG. 5 illustrates schematically a principle of the invention in a radio access network RAN according to one embodiment of the invention, which comprises a satellite SAT1 and a ground station NTN-GW. User equipment UE, for example of the smartphone type, is attached via a wireless link RL1 to this radio network RAN for accessing a mobile communication network RM (not shown).

According to this example, the satellite SAT1 carries on board at least the virtualized functions RU and DU (not shown) of the network RAN and, according to this embodiment of the invention, it comprises a device 100 for processing a connection of the user equipment UE with a piece of remote equipment (not shown) in the mobile communication network. This device 100 is configured for detecting an under-utilization of a data rate allocated over said wireless link RL1 to said connection, obtaining padding data DR, said data being stored in a memory CDN_EC accessible in the wireless access network and for example carried on board the satellite SAT1, and transmitting the padding data DR obtained over said wireless link.

The device 100 thus implements the method for processing a connection according to the invention which will be detailed hereinafter in relation with FIG. 7.

Alternatively, the device 100 may be independent of the satellite SAT1, but connected to the latter via any given link, wired or otherwise. For example, it may be integrated into another satellite, referred to as intermediary satellite, of a constellation of satellites of the RAN, or to another piece of node equipment of the access network RAN.

According to the example in FIG. 5, the satellite RAN also comprises a ground station NTN-GW, connected to the satellite SAT1 via a wireless link RL2. This ground station implements the virtualized function CU of the RAN. According to the invention, it comprises a device 200 for controlling the connection according to one embodiment of the invention. Such a device is configured for obtaining padding data DR and for transmitting the padding data to a memory (in the example envisioned here, the memory CDN_EC previously introduced) accessible in the wireless access network, for storage.

In this way, these padding data are pre-loaded into the memory and available for the aforementioned connection processing device 100.

Advantageously, the device 200 is configured for obtaining from a data table CC_DB_H200 information relating to a congestion control of the data stream and information relating to data losses of connections previously established in the wireless access network and for selecting said padding data depending at least on the information obtained.

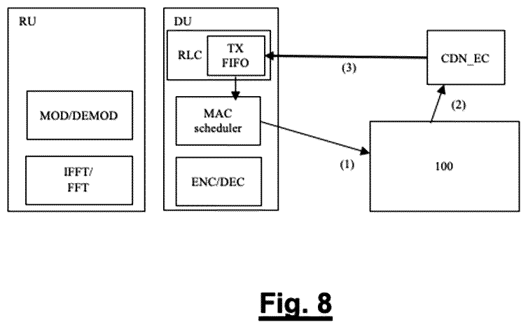

The device 200 thus implements the method for controlling a connection according to the invention, as will be detailed hereinafter in relation with FIG. 8.

Advantageously, the data table CC_DB_H200 is hosted near to the device 200, for example in the ground station NTN-GW. Advantageously, its content comes from the export of the contents of one or more data tables CC_DB_H100 of the same type, situated close to one or more satellites and processing devices 100 of various access networks RAN. FIG. 5 shows a single satellite SAT1. In other words, the data table CC_DB_H200 is a concatenation of historical data collected from various RANs, which allows a sufficiently large number of connection histories to be obtained, notably in order to implement a technique for automatic classification of these data by artificial intelligence. It should be noted that the data table CC_DB_H200 comprises additional information with respect to the tables CC_DB_100, notably relating to a context of the connection in question. It may also comprise information received on another interface, such as for example information relating to a number of connections pending in the RAN in question.

Alternatively, the device 200 may be independent of the ground station NTN-GW, but connected to the latter via any given link, wired or otherwise. For example, it may be integrated into the satellite SAT1 or another satellite, referred to as intermediary satellite, of a constellation of satellites of the RAN, or to another piece of node equipment of the access network RAN.

One advantage of locating the device 200 within the ground station NTN_GW is that it can serve several different satellite RANs. Indeed, only a few ground stations NTN_GW are installed for around a hundred satellites which each cover around a thousand kilometers and emulate around a hundred radio cells. They are distributed on the ground in such a manner that any given satellite RAN always has one or two within range for communicating with it.

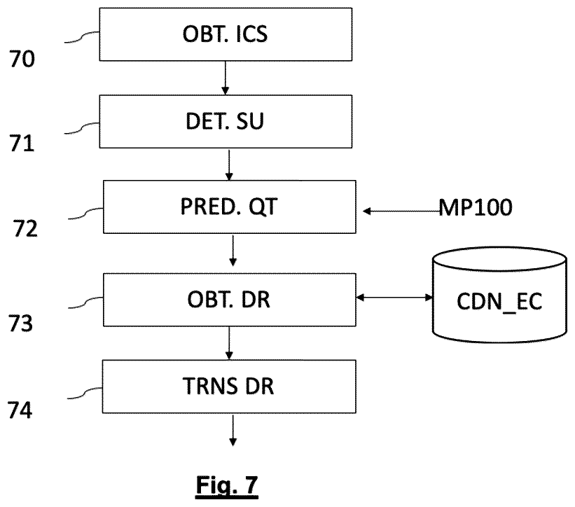

In relation with FIG. 6, another exemplary architecture of a mobile communication network RM is described comprising an access network RAN according to one embodiment of the invention. The access network RAN comprises several satellites, including the satellite SAT1 situated near to the user equipment UE and an intermediary satellite SAT2 connected to the satellite SAT1, on the one hand, and to a ground station NTN_GW1 on the other. In this example, the function DU is on board the intermediary satellite SAT2. The cache memory CDN_EC is integrated into the first satellite SAT1, together with the function RU. A function CU is hosted by each of the ground stations NTN_GW1 and NTN_GW2. The device 100 is on board the satellite SAT1 and the device 200 is hosted by the intermediary satellite SAT2, together with the data table CC_DB_H200. One advantage is that the device 200 is nearer to the device 100, which allows the latency to be limited, notably for the supply of the memory CDN_EC.

The data and control streams exchanged in the framework of the connection established or in the process of being established with the user equipment UE may be routed via two separate paths DF1, DF2 illustrated by arrows in the figure: a first via the ground station NTN_GW1 by means of the link RL2 and a second via a second ground station NTN_GW2 and the link RL3. When data losses occur over links situated upstream of the link RL1 (represented by crosses), in other words connecting equipment of the access network situated further from the user equipment UE along the path of the connection, the device 100 according to the invention is informed of this and detects an under-utilization of the resources allocated for the connection over the link RL1 (represented by a question mark).

The processing device 100, the control device 200, the memory CDN_EC and the data table CC_DB_200 constitute a system in the sense of the invention.

One exemplary embodiment is now described, in relation with FIG. 7, in the form of a flow diagram, of a method for processing a connection between user equipment, namely user equipment UE, and remote equipment, in a communication network, according to one embodiment of the invention. In the following, this method is implemented by the aforementioned device 100.

It is assumed that the user equipment UE has established or is in the process of establishing a connection with remote equipment, within the communication network. For this purpose, it has attached itself via the wireless link RL1 to a wireless network RAN for access to the communication network, for example the satellite network RAN in FIG. 5. It is assumed that the user equipment UE has requested to receive data via this connection and, to this end, radio resources have been allocated to it over the wireless link RL1.

The perspective here is within the radio access network RAN, for example within the node equipment nearest to the user equipment UE, which is assumed here to be hosted by the satellite SAT1.

It implements the function RU responsible for the modulation and demodulation and, advantageously, the function DU of the access network RAN, which carries out the encoding/decoding, assigns the bandwidth to the connection over the link RL1 and detects the data packet losses.

At 70, information ICS relating to the connection is obtained. For example, it is related to a state of this connection and indicates potential data packet losses over other radio links implemented by the connection in the network RAN, such as for example the link RL2. It may also comprise information relating to a congestion control implemented from end to end of the connection when it is established. As previously mentioned, the congestion control algorithms do not have prior knowledge of the data rate available and take several RTTs in order to converge, in other words to transmit data using all the allocated bandwidth. Also, when a connection is re-established, conditions may have changed and may lead to an inadequacy of the initial configuration, which requires a time delay in order to re-adjust the control parameters.

Finally, it may comprise information relating to the service transported by the end-to-end connection, for example a domain name, or a URL of the remote equipment or of the service requested from the connection.

At 71, an under-utilization of the radio resources allocated to the connection over the radio link RL1 is detected. In other words, the function DU is lacking data to be transmitted over this link: this is thus referred to as a “dearth” of data.

At 72, a prediction of a quantity or a duration of padding data and of a type of padding data to be requested is implemented, for example by application of a predetermined prediction model MP to the information obtained. For example, a computer program comprising code instructions for implementing the prediction model MP has previously been received by the device 100 coming from a function ML_GEN_ALG_CC. Such a function is configured for producing one or more prediction models MP with the aid of artificial intelligence techniques ML. Advantageously, this function is implemented by the device 200 according to the invention.

At 73, the quantity of padding data predicted is requested for the predicted duration from a dedicated memory CDN_EC of the access network RAN (for example a cache memory), which has been pre-loaded with padding data DR.

The padding data DR obtained may be of various types. These may be user data, at the application level, for example data for replacement of lost data, such as a degraded version of an image or text for description of the image, DNS inputs, or else information of public interest common to the cell such as a weather report, or else public information common to a geographical region such as a local, called segmented, advertisement. As an alternative, these can be technical data of the lower level protocol layers according to the OSI model, such as for example ICMP exchanges, application control data, such as software update data, or else 5G control data or radio control data. Lastly, these data may be program code instructions allowing padding data to be generated based on parameters, such as for example text, an image or music. In the latter case, the processing method generates padding data based on instructions and parameters obtained.

At 74, the padding data obtained are transmitted over the radio link LR1 to the user equipment UE. They may be transmitted in various ways over the wireless link RL1, depending on their type and the application of the user equipment for which they are intended. Several embodiments will be detailed hereinafter.

In relation with FIG. 8, the case of a scenario according to which the virtualized functions RU and DU are on board the satellite SAT1 (scenario “RU/DU on board”) is now detailed. In particular, the function DU implements, within the layer 2 or MAC layer, a MAC scheduler responsible for allocating the radio resources up to the user equipment UE, a controller of the radio link conforming to the RLC (Radio Link Control) protocol, such as defined by the 3GPP, responsible for detecting and correcting the transmission errors, and a congestion controller (CC controller) responsible for detecting and correcting the congestions over the radio links implemented by the connection. The controller RLC is configured for controlling a transmission data queue TX FIFO (First In First Out).

According to this embodiment of the invention, the device 100, associated with the function DU, upon request from the MAC scheduler at (1), detects that there will be a lack of data to be transmitted over the radio link RL1, determines the quantity of lacking data, sends at (2) a request to obtain the quantity determined of padding data to the cache memory CDN_EC and, at (3), switches the output of the queue of data to be transmitted FIFO onto that of the cache memory CDN_EC.

Advantageously, depending on their type and on the targeted application of the user equipment UE, the padding data DR are inserted into an existing data stream of said connection.

One advantage is that use is made of the established connection and that the insertion of the padding data is effected as a “background task”. For example, the padding data are inserted at the physical level (layer 1 of the OSI model) into the RB (Resource Block) sub-frames allocated for transporting the data packets sent by the remote server equipment to the user equipment UE.

This may be a control data stream or a user data stream depending on a type of the padding data. The padding data of the user type are inserted into the available sub-frames of a data stream transmitted over the user channel C-U, whereas the padding data of the control type are inserted into the available sub-frames of a signaling stream transmitted over the control channel C-C of the link LR1.

It will be understood that this embodiment involves a re-arrangement of the sub-frames in order to insert the padding data into them. For example, such a re-arrangement comprises the selection of a more robust type of encoding, of the eMBB (enhanced Mobile Broadband) or the mMTC (massive Machine Type Communications) type, or else the URLLC (Ultra-Reliable Low Latency Communications) type for increasing the quality of reception to the detriment of the volume of data transmitted. Depending on the quantity of data of each type, the distribution of the resources provided for each channel may be adapted depending on a quantity of padding data DR of each type of the data to be transmitted over the link LR1. For example, if the padding data comprise a significant part of control data, a larger part of bandwidth is assigned to the control channel than to the data channel in order to allow their transmission over the link LR1.

According to a first example, they may be transmitted at the physical level (layer 1 of the OSI model) by re-arranging the sub-frames allocated to the connection. The control data are sent in the control channel and the application data in the user channel, these two channels pre-existing in the connection.

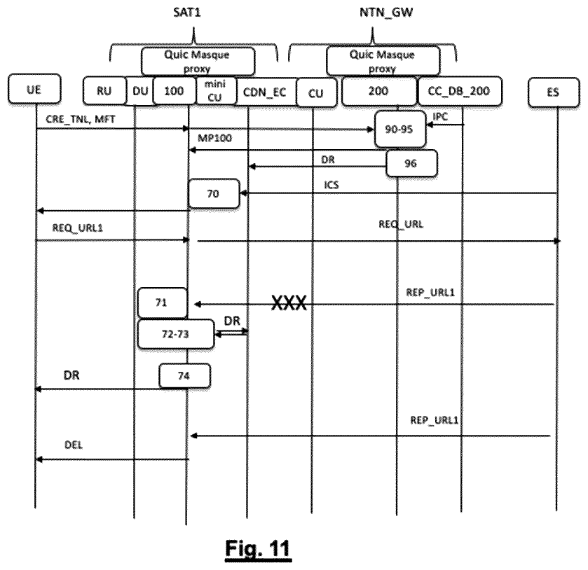

According to another example, if the data are application data specific to the application having established the connection, for example the web browser of the user equipment UE, they may be transmitted within a dedicated data stream created on one link section of the connection (at level 3 of the OSI model), between the memory CDN_EC and the user equipment, for example by means of a technology of the QUIC/MASQUE type which will be detailed hereinafter in relation with FIG. 11. According to this technology, network equipment of the proxy type, called QUIC/MASQUE proxy, is placed so as to intercept messages exchanged in the framework of the connection within the transport layer and it is configured for aggregating information relating to the connection notably in terms of congestion control for each of the ends of the connection, in other words the server equipment end and the user equipment UE end.

This mode of transmission is adapted to control data or user data intended for the application having established the connection.

According to one variant, the processing device 100 creates a dedicated radio connection with the user equipment UE or else an IP tunnel.

According to yet another example, if these data are intended for another, non-IP, application of the user equipment, or for a function of the operating system of the user equipment, they may, if this application supports it, be transmitted as USSD (Unstructured Supplementary Service Data), at level 2 of the OSI model or, otherwise, via another channel in parallel with the connection.

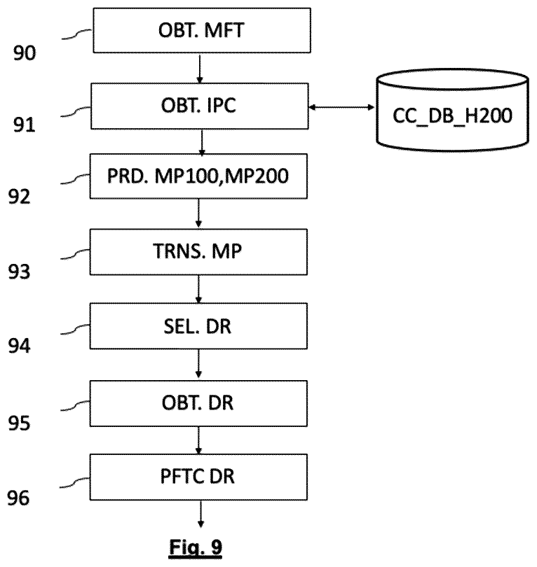

In relation with FIG. 9, one exemplary embodiment is now described, in the form of a flow diagram, of a method for controlling a connection between user equipment, for example user equipment UE, attached via a wireless link RL1 to a network for access to a communication network and other remote equipment, for example a server, according to one embodiment of the invention.

In a similar manner to previously, in this example, the case is considered of a mobile communication network and of a satellite access network RAN, for example such as illustrated in FIG. 5, and it is considered that the method is implemented by a control device 200 on board an intermediary satellite or in the ground station NTN-GW. Advantageously, the device 200 is located close to the node equipment of the access network RAN, for example the ground station NTN_GW1 in FIG. 6 implementing the virtualized function CU. In this way, the latency is limited as far as possible.

During an optional step 90, information MFT relating to the user equipment UE is obtained. This is for example description information, also referred to as manifest MFT, relating to a state of memories, for example of cache memories of the user equipment UE. It notably informs on the state of a DNS cache memory of the user equipment UE, the state of its Web cache memory, the state of the versions of the libraries of its operating system, the state of security data of its firewalls depending on predetermined attack patterns, etc. It allows the selection of padding data adapted to the user equipment and in particular of a type of these data.

At 91, other information IPC relating to a congestion control implemented and to data losses that occurred during previous connections involving the access network RAN is obtained from a data table CC_DB_H200 accessible in the network RAN. Advantageously, it is stored close to the device 200, for example in the ground station NTN-GW. It is for example organized in the form of a database and indexed by an identifier of the user equipment UE.

Table 1 hereinbelow shows examples of information obtained from the data table CC_DB_H200. The user equipment UE is for example identified by an IP address and the remote server equipment ES by a URL. The associated information relates to a type of congestion control (corresponding to (1) AIMD (additive increase/multiplicative decrease), (2) loss based, (3) delay based, (4) rate based, (5) and beyond: dynamically discovered according to an artificial intelligence or ML (Machine Learning) method, a convergence time, a packet loss profile: an observed number of consecutive losses and the average number of attached losses, in other words ‘burst losses’, etc.).

TABLE 1

| | | CC | Convergence | Packet loss profile |
|---|---|---|---|---|
| Connection | Server | type | time | (nb, burst losses) |
| ID1 | youtube.com | 3 | 20 | 1, 3 |
| ID2 | orange.com | 1 | 30 | 2, 1 |
| ID3 | domaine.com | 12 | 50 | 4, 0 |

At 92, padding data are obtained for the user equipment UE using information obtained at 90 and 91. For example, they are obtained from one or more data sources, with the aid of a predetermined prediction model MP, MP200 which takes as input the information obtained and produces one or more types of padding data, adapted to the connection. For example, the device 200 chooses the data source depending on the type or types produced at the output of the prediction model.

Advantageously, at 93, the historical data from the data table CC_DB_H200 are used in a prior phase for producing or updating at least a first prediction model MP100, designed to be used, on the one hand, by the device 200 itself for selecting padding data adapted to the user equipment UE and pre-positioning them in the memory CDN_EC and, on the other hand, a second prediction model MP200 designed to be used by the processing device 100 for determining a quantity of padding data to be requested from the memory CDN_EC.

As a variant, a single ‘multi-target’ prediction model MP is determined.

Such a prediction model is for example implemented by a decision system implementing artificial intelligence or ML (Machine Learning) techniques, configured for determining output parameters based on input parameters comprising the connection and state information on the memories of the user equipment previously obtained.

For example, the parameter or parameters supplied at the output of the prediction model MP_DU relate to the padding data to be pre-positioned in the memory CDN_EC and to be sent in push mode, in other words automatically, without the user equipment having requested any, over the various layers of the connection between the user equipment and the remote equipment. They indicate the data and/or the types of data to be pre-positioned in the memory. For example, they describe the following data:
a control datum at the radio layer level relating to a probability of loss of radio signal;
one or more control data at the 5G layer level, for example as USSD to a non-IP application or to a function of the operating system of the user equipment UE;
one or more control data at the application level relating to DNS inputs. These DNS inputs have for example been chosen based on probabilities of usage of a domain by another piece of user equipment in a Web page;
one or more data at the application level relating to one or more segmented advertisements, in other words targeted according to the broadcast region of the television viewer;
instructions for generating padding data, for example interlude music, text or an image for replacement of lost data, etc.

For example, the device 200 obtains the output parameters previously listed after having supplied the following information at the input of the prediction model, shown in table 2:

TABLE 2

| | | | | Profile of packet |
|---|---|---|---|---|
| | Remote/server | Type of | Convergence | loss (nb, nb of |
| Connection | equipment | CC | time | burst losses) |
| ID1 | Orange.com | 1 | 24 | 1, 3 |

At 94, the padding data are selected as a function of the output parameters obtained and transmitted, at 95, to the memory CDN-EC. In this regard, it is noted that the memory CDN_EC is advantageously structured in such a manner that the padding data selected for the user equipment UE are accessible for this equipment. For example, they are indexed by an identifier of the connection between the user equipment UE and the remote equipment ES, such as for example a sequence number.

It is noted that this transmission may take place according to various modes:
within data or control streams of the connection of the user equipment with the remote equipment ES;
in a dedicated connection. For example the memory CDN_EC which stores the padding data DR is seen as a 5G end-point;
in a dedicated tunnel of the VPN (Virtual Private Network) type created between the memory CDN_EC and the user equipment UE.

Thus, the device 200 according to the invention pre-supplies the memory CDN-EC of the network RAN such that padding data are available when the device 100 detects a dearth of data over the wireless link between the user equipment UE and the access network RAN.

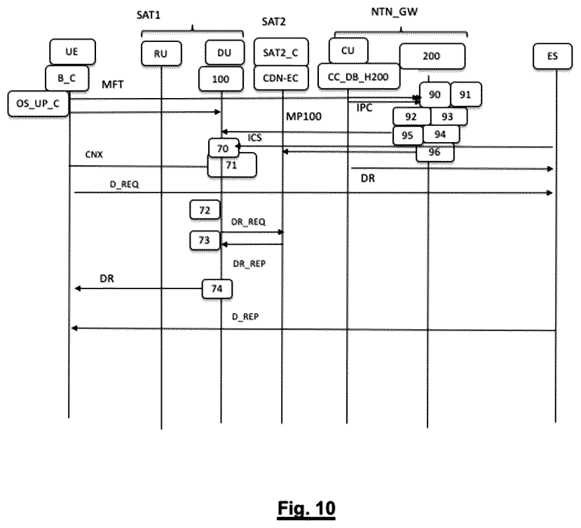

In relation with FIG. 10, a flow chart of the exchanges between the user equipment UE and the various entities of the network RAN according to one exemplary embodiment of the invention is now described. In this example, the functions RU/DU of the RAN and the processing device 100 according to the invention are on board the satellite SAT1, and the cache memory CDN_EC is located close to the function DU in the satellite SAT1. As far as the function CU, the control device 200 and the table CC_DB_H200 are concerned, they are hosted by the ground station NTN_GW, in accordance with the diagram in FIG. 5.

It is assumed that the user equipment UE attaches itself via a radio link to the satellite SAT1 of the RAN and that it establishes an end-to-end connection, of the TCP or QUIC type for example, with the remote server equipment ES.

Before the device 100 detects an under-utilization of the data, the control device 200 pre-supplies the cache memory CND_EC with padding data DR adapted to the user equipment UE. For this purpose, during the attachment to the access network or the establishment of the connection, at 90, the user equipment UE transmits to it information relating to the state of its various cache memories, for example that of a cache memory B_C of its browser or that of a memory OS_UP_C configured for storing data for updating its operating system. At 91, the device 200 obtains connection information relating to previous connections ICP from the data table CC_DB_H200. At 92, the device 200 produces a first prediction model MP100 for description parameters of padding data and transmits it, at 93, to the device 100. At 94, the device 200 uses a second prediction model MP200 for selecting types of padding data based on the information obtained and, at 95, it requests from one or more predetermined sources padding data of the selected types. For example, the device chooses to address a request for obtaining data to a particular source of data, for example a memory or a data table of the communication network, depending on a desired type of data. The quantity of padding data selected depends on the memory space available in the memory CDN_EC.

As a variant, a single multi-target prediction model MP is produced and used by the devices 100 and 200 according to the invention.

It is noted that, if the memory CDN_EC is full, padding data previously stored, but unused, may be deleted in order to make room for the new data.

At 96, the device 200 transmits the padding data received to the memory CDN_EC.

As a variant, the device 200 may also pre-position padding data in the memory CDN_EC on the basis of another connection established by the same user equipment UE with remote equipment or else by other user equipment.

When the end-to-end connection between the user equipment UE and the remote equipment ES is created, at 70, the device 100 sends a request to obtain information ICS relating to the connection. For example, this comprises information relating to a congestion control implemented from end to end of the connection when it is established.

At 71, it detects an under-utilization of the resources allocated to the connection, for example at the establishment of the connection, and the time needed for the congestion control algorithm to converge. At 72, it predicts a quantity of padding data to be requested, based on the information obtained and on the prediction model MP, MP100. At 73, it requests the quantity of padding data DR predicted from the memory CDN_EC and, at 74, it transmits it over the link LR1 to the user equipment UE, for example by inserting it into user data streams or control data streams, using the unused elements of radio resource.

The invention that has just been described has numerous applications.

One exemplary embodiment of the invention is described hereinafter, in relation with FIG. 11, for the updating of cache memories or of particular applications of the user equipment UE.

In this example, the satellite SAT1 carries on board not only the functions RU and DU and the processing device 100 according to the invention, but also a “mini CU” function, configured for intervening at certain stages of one or more application connections of the user equipment UE, identified by the processing device 100. Furthermore, according to this example, the satellite SAT1 also carries on board a proxy module of the QUIC/MASQUE type configured for creating a QUIC data stream dedicated to the exchanges of padding data DR between the device 100 and the user equipment UE. The ground station NTN_GW carries on board the function CU, the device 200, the table CC_DB_H200 and a distributed QUIC/MASQUE proxy.

It is assumed that, following its request for establishment of a connection, the user equipment UE establishes a communication tunnel (CRE_TNL) with the QUIC/MASQUE proxy module of the satellite SAT1.

During the attachment or the establishment of the connection, the user equipment UE, or more precisely the user agent of the web browser of the user equipment, sends description information MFT on the state of its caches (Web, DNS, advertisement, etc.) via the tunnel, for example in the form of manifests transmitted in a connection request message “CONNECT” of the MASQUE protocol, to this proxy in addition to a request for access to a URL “URL1”, for example in the form of a message GET_URL1 according to the HTTP3 protocol.

The proxy of the satellite SAT1 receives these manifests and the access request GET_URL1. It retransmits the access request GET URL1 to the server equipment ES and the manifests to the proxy of the ground station whose device 200 identifies the contents of the manifests to be refreshed taking into account the manifests received together with other criteria (an obsolescence of the manifests received, the presence of other user equipment, the existence of contracts for example of the advertisement type, etc). The device 200 prepares the update of these contents and pre-positions the data packets of the Web or DNS contents selected in the cache memory CDN_EC of the satellite SAT1, by implementing the control method according to the invention (90-96). Upon receipt by the function DU of a first train of response data packets REP_URL1 responding to the request GET_URL1 of the UE, coming from the server equipment ES, the function DU detects a loss of packets between the function CU and the function RU (or DU). The device 100 is informed of this and detects, at 71, an under-utilization of the radio resources allocated to the connection between the user equipment UE and the server equipment ES. At 73, it therefore obtains padding packets DR pre-positioned in the cache memory CDN_EC and sends them, at 74, in the QUIC/MASQUE tunnel in place of the lost data packets. The satellite sends back the first train of lost packets from the response; they are transmitted to the user equipment (DEL).

According to one variant, no manifest is transmitted by the user equipment UE. In this case, the padding data DR are selected by the control device 200. These are for example DNS inputs selected by the function DU. Advantageously, according to this embodiment, the function DU indicates to the user equipment UE that it is providing an online DNS resolver function (“resolverless”), for example of the DNS over HTTPS (or DoH), DNS over TLS (or DOT) or else DNS over QUIC (or DOQ) type, known per se.

Advantageously, the two embodiments are combined in order to reduce the loading time of the web pages by pushing both web pages and DNS inputs used by the user equipment UE.

In what has just been described, the padding data are transmitted over the downlink, from the satellite to the user equipment UE. Of course, and as already mentioned, the invention is also applicable to the uplink.

The case is for example considered of usage according to which two software applications APP1 and APP2 are active on the user equipment UE. The latter also has an on board cache memory MC_UE according to the invention, in which padding data are pre-positioned. It also comprises the processing device 100 according to the invention and the control device 200 according to the invention. For example, the device 100 is integrated into the operating system OS or into the network card of the user equipment UE and the device 100 is hosted at the application level.

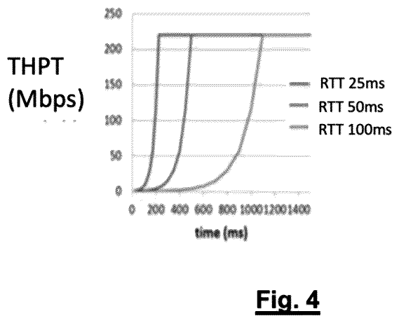

It is assumed that the second application APP2 is already connected to a piece of remote server equipment ES2 via a connection CNX2. The application APP1 connects via another connection CNX1 to another server ES1. When this connection is established, the congestion control carries out a slow start and, as illustrated in FIG. 4, an under-utilization of the resources allocated is detected by the device 100, which obtains padding data dedicated to the application APP2 from the cache memory MC_UE and transmits them in the form of a data burst in the connection CNX1. The transmission cadence of these data decreases as a function of the trend in the convergence of the congestion control algorithm over time.

The invention is also applicable in a network RAN (not shown) comprising a satellite SAT1 connected to a ground station NTN_GW via a first direct path and via a second indirect path, via another satellite. According to the invention, the satellite SAT1 obtains the prediction models and the padding data from the control devices on board each of the two ground stations. The invention therefore allows the satellite SAT1 to use two prediction models and two tables of padding data, without immediately changing ground station.

The method is also applicable to a terrestrial 5G radio access network RAN, in particular when it comprises relay equipment or transponders which increase the distance and hence the time delay between the UE and the function CU.

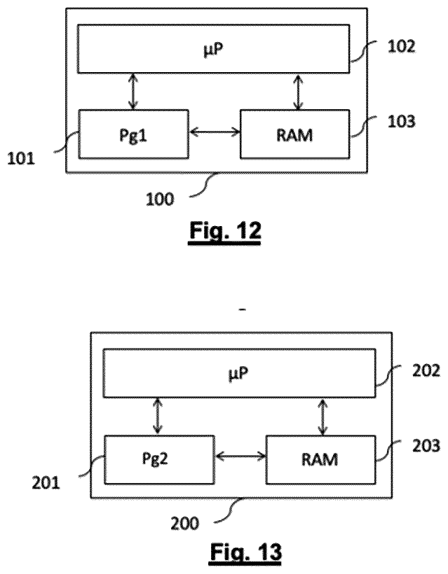

In relation with FIG. 12, one example is now described of a hardware structure of a device 100 for processing a connection between user equipment and remote equipment, in a communication network, said user equipment being attached to a wireless access network of said communication network via a wireless link, comprising a module for detecting an under-utilization of a data rate allocated over said wireless link to said connection, a module for obtaining padding data, said data being stored in a memory accessible in the wireless access network; and a module for transmission of the padding data obtained over said wireless link.

The term “module” may just as easily correspond to a software component as to a hardware component or to an assembly of hardware and software components, a software component itself corresponding to one or more computer programs or sub-programs or, more generally, to any element of a program capable of implementing a function or a set of functions.

More generally, such a device 100 comprises a volatile memory 103 (for example a RAM memory), a processing unit 102 equipped for example with a processor, and controlled by a computer program Pg1, representative of the detection, acquisition and transmission modules, stored in a non-volatile memory 101 (for example a ROM memory or a hard disk). Upon initialization, the code instructions of the computer program are for example loaded into the volatile memory 103 before being executed by the processor of the processing unit 102. The volatile memory 103 may also contain the padding data obtained.

FIG. 12 illustrates only one particular way, amongst several possible ways, of implementing the device 100 in order for it to carry out the steps of the method for processing a connection such as detailed hereinabove, in relation with FIG. 7, in its various embodiments. Indeed, these steps may just as easily be carried out on a reprogrammable computing machine (a PC computer, a DSP processor or a microcontroller) executing a program comprising a sequence of instructions, as on a dedicated computing machine (for example an assembly of logic gates such as an FPGA or an ASIC, or any other hardware module).

In the case where the device 100 is implemented with a reprogrammable computing machine, the corresponding program (in other words the sequence of instructions) could be stored in a removable storage medium (such as for example an SD card, a USB memory stick, a CD-ROM or a DVD-ROM) or otherwise, this storage medium being partially or totally readable by a computer or a processor.

The various embodiments have been described hereinbefore in relation with a device 100 integrated into a satellite of a satellite radio access network RAN, but it may also be integrated into a ground station or any other node equipment of a wireless access network.

In relation with FIG. 13, one example is also described of a hardware structure of a control device 200 between user equipment of a communication network and remote equipment, said user equipment being attached via a wireless link to a wireless access network of said communication network, comprising a module for obtaining padding data intended to be transmitted via said connection in the case of detection of an under-utilization of the resources allocated to this connection by the wireless access network and a module for transmitting the padding data obtained to a memory accessible in the wireless access network, for storage.

The term “module” may just as easily correspond to a software component as to a hardware component or to an assembly of hardware and software components, a software component itself corresponding to one or more computer programs or sub-programs or, more generally, to any element of a program capable of implementing a function or a set of functions.

More generally, such a device 200 comprises a volatile memory 203 (for example a RAM memory), a processing unit 202 equipped for example with a processor, and controlled by a computer program Pg2, representative of the acquisition and transmission modules, stored in a non-volatile memory 201 (for example a ROM memory or a hard disk). Upon initialization, the code instructions of the computer program are for example loaded into the volatile memory 203 before being executed by the processor of the processing unit 202. The volatile memory 203 may also contain the padding data selected prior to their transmission.

FIG. 13 illustrates only one particular way, amongst several possible ways, of implementing the device 200 in order for it to carry out the steps of the method for controlling a connection such as detailed hereinabove, in relation with FIG. 8, and in its various embodiments. Indeed, these steps may just as easily be carried out on a reprogrammable computing machine (a PC computer, a DSP processor or a microcontroller) executing a program comprising a sequence of instructions, as on a dedicated computing machine (for example an assembly of logic gates such as an FPGA or an ASIC, or any other hardware module).

In the case where the device 200 is implemented with a reprogrammable computing machine, the corresponding program (in other words the sequence of instructions) could be stored in a removable storage medium (such as for example an SD card, a USB memory stick, a CD-ROM or a DVD-ROM) or otherwise, this storage medium being partially or totally readable by a computer or a processor.

1. A method for processing a connection between user equipment and remote equipment within a communication network, said user equipment being attached to a wireless access network of said communication network via a wireless link, wherein said method is implemented by a processing device and comprises:
detecting an under-utilization of a data rate allocated over said wireless link to said connection;
obtaining padding data, said data being stored in a memory accessible within the communication network; and
transmitting the padding data obtained over said wireless link.

2. The method for processing a connection as claimed in claim 1, wherein the detection of an under-utilization of a data rate comprises detecting a loss of data packets over another link of the access network implemented by the connection and wherein the padding data are obtained then transmitted following a request for retransmission of lost packets and prior to receipt of the retransmitted packets.

3. The method for processing a connection as claimed in claim 1, wherein the detection of an under-utilization of a data rate comprises detecting an establishment and/or re-establishment of said connection and wherein the padding data are obtained then transmitted during a period of convergence of a congestion control.

4. The method for processing a connection as claimed in claim 1, wherein the method comprises obtaining information relating to the connection and of predicting a quantity of said padding data to be requested, by application of a predetermined prediction model to the information obtained.

5. The processing method as claimed in claim 1, wherein the padding data are transmitted over a control channel and/or over a user channel of the wireless link, the channel used for the transmission being determined by a type of the padding data.

6. The processing method as claimed in claim 1, wherein the padding data are inserted into a data stream of said connection.

7. A method for controlling a connection between user equipment of a communication network and remote equipment, said user equipment being attached via a wireless link to a wireless access network of said communication network, wherein the method is implemented by a controlling device and comprises:
obtaining padding data intended to be transmitted via said connection in in response to detection of an under-utilization of the resources allocated to this connection by the wireless access network; and
transmitting the padding data obtained to a memory accessible within the communication network, for storage.

8. The control method as claimed in claim 7, wherein the padding data are transmitted to said memory in at least one data stream of the connection.

9. The control method as claimed in claim 7, wherein the method comprises obtaining of information relating to a congestion control of the data stream and of information relating to data losses of previous connections in the wireless access network from a data table and in wherein the method comprises selecting the padding data depending at least on the information obtained.

10. The method for controlling a connection as claimed in claim 9, wherein the method comprises obtaining at least one prediction model for padding data using the information contained in the data table and transmitting said model in the wireless access network to a processing device configured for detecting an under-utilization of resources allocated to said connection over a wireless link between the user equipment and the access network, predicting padding data to be used for said connection based on said prediction model and transmitting the predicted padding data over the wireless link.

11. The method for controlling a connection as claimed in claim 7, wherein the method furthermore comprises obtaining of information, coming from the user equipment, relating to a state of at least one cache memory of said user equipment and selecting padding data adapted to the user equipment depends on the information obtained.

12. A processing device for processing a connection between user equipment and remote equipment within a communication network, said user equipment being attached to a wireless access network of said communication network via a wireless link, wherein said processing device comprises:
at least one processor; and
at least one non-transitory computer readable medium comprising instructions stored thereon which when executed by the at least one processor configure the processing device to:
detect an under-utilization of a data rate allocated over said wireless link to said connection; and
obtain padding data, said data being stored in a memory accessible within the communication network; and
transmit the padding data obtained over said wireless link.

13. A control device for controlling a connection established between user equipment of a mobile communication network and remote equipment, said user equipment being attached to a wireless access network of said communication network, wherein the control device comprises:
at least one processor; and
at least one non-transitory computer readable medium comprising instructions stored thereon which when executed by the at least one processor configure the control device to:
obtain padding data intended for said at least one connection; and
transmit the padding data to a memory accessible within the communication network for storage.

14. A satellite of the wireless access network of the communication network, to which the user equipment is attached via the wireless link, wherein the satellite comprises the processing device as claimed in claim 12 and the memory which is configured for storing the padding data.

15. (canceled)

16. A ground station of the wireless access network of the communication network to which the user equipment is attached via the wireless link, wherein the ground station comprises the control device as claimed in claim 13 and a data table comprising information on congestion and on data losses relating to previous connections.

17. A non-transitory computer readable medium comprising a computer program stored thereon comprising program code instructions for implementing the method as claimed in claim 1, when it is the instructions are executed by a processor of the processing device.

18. A non-transitory computer readable medium comprising a computer program stored thereon comprising program code instructions for implementing the method as claimed in claim 7, when the instructions are executed by a processor of the controlling device.
